(19) United States
(12) Patent Application Publication
(10) Pub. No.: US 2025/0191131 A1
(43) Pub. Date: Jun. 12, 2025

(54) VIDEO PROCESSING METHOD, APPARATUS, ELECTRONIC DEVICE AND STORAGE MEDIUM

(71) Applicant: Beijing Zitiao Network Technology Co., Ltd., Beijing (CN)

(72) Inventors: Hongen JIE, Beijing (CN); Jicheng Wang, Beijing (CN); Zhiyong Dai, Beijing (CN)

(21) Appl. No.: 18/961,320

(22) Filed: Nov. 26, 2024

(30) Foreign Application Priority Data
Dec. 11, 2023 (CN) 202311694667.1

(51) Int. Cl. G06T 5/50; G06T 5/70; G06T 7/00

(52) U.S. Cl. CPC G06T 5/50; G06T 5/70; G06T 7/0002; G06T 2207/10016; G06T 2207/20182; G06T 2207/30168

(57) ABSTRACT

The present disclosure relates to a video processing method, an apparatus, an electronic device and a storage medium. The method includes: obtaining frame cadence information between a source video and a target transcoded video, wherein the frame cadence information represents a video frame correspondence between the source video and the target transcoded video, and the target transcoded video includes a video obtained by transcoding the source video; obtaining, based on the frame cadence information, a target processing result of the target transcoded video.

### CROSS-REFERENCE TO RELATED APPLICATION

The present application claims priority of Chinese Patent Application No. 202311694667.1, filed on Dec. 11, 2023, and the entire content disclosed by the Chinese patent application is incorporated herein by reference as part of the present application for all purposes under the U.S. law.

### TECHNICAL FIELD

The present disclosure relates to the field of video technology, and in particular to a video processing method, an apparatus, an electronic device and a storage medium.

### BACKGROUND

With the continuous development of technology, terminal products represented by mobile phones have been widely used. A user can play a related video through a terminal. In related technologies, problems may occur during the transcoding process of the video, which makes it impossible to further accurately process the transcoded video, and results in low efficiency during video processing of the related technologies.

### SUMMARY

At least one embodiment of the present disclosure provides a video processing method, which comprises:
obtaining frame cadence information between a source video and a target transcoded video, wherein the frame cadence information represents a video frame correspondence between the source video and the target transcoded video, and the target transcoded video comprises a video obtained by transcoding the source video;
obtaining, based on the frame cadence information, a target processing result of the target transcoded video.

At least one embodiment of the present disclosure further provides an electronic device, which comprises:
at least one processor;
at least one memory, configured to store instructions executable by the at least one processor;
wherein the at least one processor is configured to execute the instructions to implement a video processing method, which comprises:
obtaining frame cadence information between a source video and a target transcoded video, wherein the frame cadence information represents a video frame correspondence between the source video and the target transcoded video, and the target transcoded video comprises a video obtained by transcoding the source video;
obtaining, based on the frame cadence information, a target processing result of the target transcoded video.

At least one embodiment of the present disclosure further provides a non-transient computer-readable storage medium, comprising computer-executable instructions, wherein the computer-executable instructions, upon being executed by a computer processor, perform a video processing method, comprising:
obtaining frame cadence information between a source video and a target transcoded video, wherein the frame cadence information represents a video frame correspondence between the source video and the target transcoded video, and the target transcoded video comprises a video obtained by transcoding the source video;
obtaining, based on the frame cadence information, a target processing result of the target transcoded video.

### BRIEF DESCRIPTION OF DRAWINGS

More details, features and advantages of the present disclosure are disclosed in the following description of exemplary embodiments in conjunction with the drawings, in which:

FIG. 1 is a schematic diagram of a scenario provided by an exemplary embodiment of the present disclosure;

FIG. 2 is a schematic diagram of another scenario provided by an exemplary embodiment of the present disclosure;

FIG. 3 is a flowchart of a video processing method provided by an exemplary embodiment of the present disclosure;

FIG. 4 is a schematic block diagram of functional modules of a video processing apparatus provided by an exemplary embodiment of the present disclosure;

FIG. 5 is a structural block diagram of an electronic device provided by an exemplary embodiment of the present disclosure; and

FIG. 6 is a structural block diagram of a computer system provided by an exemplary embodiment of the present disclosure.

### DETAILED DESCRIPTION

The above and other features, advantages, and aspects of each embodiment of the present disclosure may become more apparent by combining drawings and referring to the following specific implementation modes. In the drawings throughout, same or similar drawing reference signs represent same or similar elements. It should be understood that the drawings are schematic, and originals and elements may not necessarily be drawn to scale.

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units. Modifications of “one” and “more” mentioned in the present disclosure are schematic rather than restrictive, and those skilled in the art should understand that unless otherwise explicitly stated in the context, it should be understood as “one or more”.

The names of messages or information exchanged between multiple apparatuses in the embodiments of the present disclosure are illustrative and not to limit the scope of the messages or information.

It is to be understood that before using technical solutions disclosed in various embodiments of the present disclosure, a user should be notified of the type, scope of use, use scene and the like of personal information involved in the present disclosure in an appropriate manner according to relevant laws and regulations, and authorization from the user should be acquired.

For example, in response to receiving an active request from a user, prompt information is sent to the user to explicitly remind the user that the requested operation requires acquisition and use of personal information of the user. Therefore, the user can independently choose, according to the prompt information, whether to provide personal information to software or hardware, such as an electronic device, an application program, a server, or a storage medium, etc., for executing operations of the technical solution of the present disclosure.

In an alternative but non-limiting implementation, in response to receiving the active request from the user, the manner in which the prompt information is sent to the user may be, for example, in the form of a pop-up window in which the prompt information may be presented in text. Additionally, the pop-up window may also carry a selection control for the user to select “agree” or “disagree” to determine whether to provide personal information to the electronic device. It is to be understood that the preceding process of notifying the user and obtaining authorization from the user is illustrative and does not limit the embodiments of the present disclosure, and that other manners complying with relevant laws and regulations may also be applied to the embodiments of the present disclosure.

During the process of video transcoding, due to transcoding technology and other reasons, it may occur that the number of video frames in the source video before transcoding is inconsistent with the number of video frames of the transcoded video. And usually, the video frames before and after transcoding are associated according to their frame sequence numbers. If the number of video frames before transcoding is inconsistent with the number of video frames after transcoding, the video frames before and after transcoding will not be accurately matched.

For ease of illustration, in the embodiment, the video before transcoding can be taken as a source video, and the video finally obtained after transcoding can be taken as a target transcoded video.

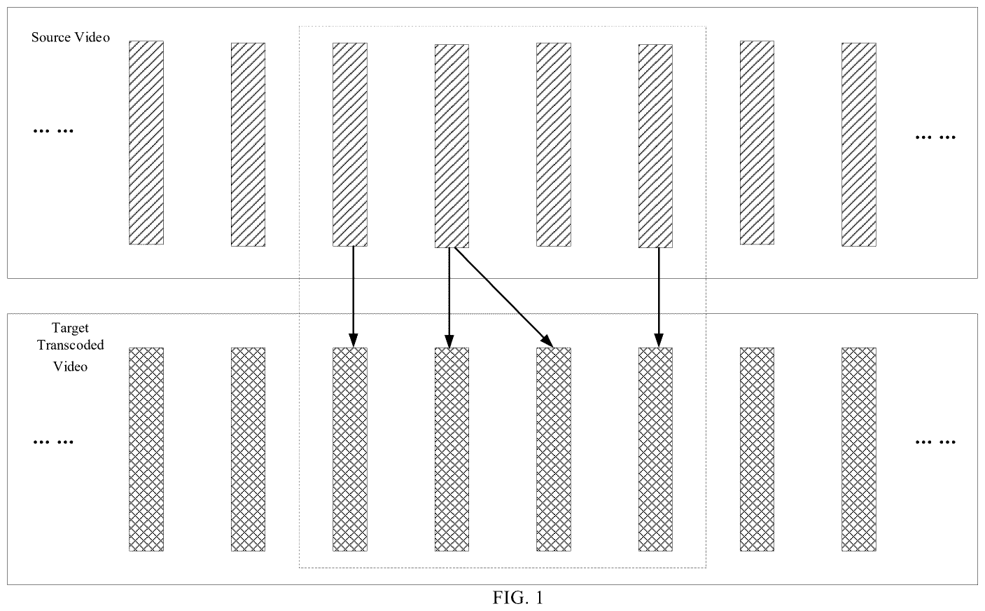

For example, the number of video frames in the source video may be 3,000 frames, while the target transcoded video obtained by transcoding the source video may increase or decrease several frames compared with the source video. If the frame sequence numbers of the source video and the target transcoded video are compared, there will be a misalignment phenomenon between the video frames of the source video and the transcoded target video after transcoding. Illustratively, as shown in FIG. 1, FIG. 1 shows part of video frames in a source video and part of video frames in a transcoded target video. As can be seen from FIG. 1, during the process of transcoding the part of video frames in the virtual frame of the source video, the corresponding video frames obtained after transcoding are misaligned, so that it is impossible to accurately match the video frames in the source video with the video frames in the target transcoded video according to the frame sequence numbers. And even if the number of video frames in the source video is consistent with the number of video frames in the target transcoded video, the video frames in the source video may not be directly aligned with the video frames in the target transcoded video due to misalignment and other phenomena that may occur during transcoding.

Therefore, in the embodiment of the present disclosure, during the process of transcoding the source video, frame cadence information between the video frames of the source video and the transcoded target video after transcoding, and the frame cadence information represents a video frame correspondence between the source video and the target transcoded video, so that the frame cadence information can be more widely used during processing the target transcoded video, and further, a more accurate processing result of the target transcoded video can be obtained.

For example, according to the frame cadence information, a more accurate video quality evaluation of the target transcoded video can be achieved by one-to-one correspondence between the video frames in the target transcoded video and the video frames in the source video, thus avoiding the possibility of disbelief in the video quality evaluation result of the target transcoded video due to the inaccurate correspondence between the video frames in the source video and the video frames in the target transcoded video.

In an embodiment, the noise caused by transcoding in the target transcoded video can also be denoised by combining the above frame cadence information. The one-to-one correspondence between the video frames in the target transcoded video and the video frames in the source video can be achieved through the frame cadence information, and therefore, the noise in the target transcoded video can be accurately located by comparing the video frames in the target transcoded video with the video frames in the source video one by one, and then the denoising processing of the target transcoded video can be realized.

In an embodiment, the transcoding processing of the source video can also be realized in the cloud, and the frame cadence information can be obtained. By sending the target transcoded video after transcoding and the frame cadence information to the terminal, the decoder on the terminal side can decode the target transcoded video, and achieve better HDR (High Dynamic Range Imaging) or super-resolution processing, etc., of the decoded video in combination with the frame cadence information, so that the user can watch videos with better image quality on the terminal.

Specifically, during the process of transcoding the source video to obtain the target transcoded video, multiple times of transcoding may occur, which requires obtaining the frame cadence information of each video before and after transcoding; and then, according to each frame cadence information, the frame cadence information between the source video and the target transcoded video is finally obtained.

Illustratively, an intermediate transcoded video can be obtained by transcoding the source video. During the transcoding process of the source video, first frame cadence information between the source video and the intermediate transcoded video can be obtained by determining the video frame correspondence between the source video and the intermediate transcoded video.

Similarly, the target transcoded video can be obtained by transcoding the intermediate transcoded video. During the transcoding process of the intermediate transcoded video, second frame cadence information between the intermediate transcoded video and the target transcoded video can be obtained by determining the video frame correspondence between the intermediate transcoded video and the target transcoded video.

In this way, according to the first frame cadence information and the second frame cadence, frame cadence combination information can be obtained by combining the first frame cadence information and the second frame cadence information, and then the frame cadence information between the source video and the target transcoded video can be determined. In an embodiment, during the above-mentioned transcoding process, more intermediate transcoded videos may appear, and the frame cadence information between the source video and the target transcoded video can be finally determined through the frame cadence information obtained from the intermediate transcoded videos before and after transcoding. Similarly, if the target transcoded video is obtained by transcoding the source video without intermediate transcoded videos, the frame cadence information between the source video and the target transcoded video can be directly obtained during the transcoding process, but the embodiment is not limited thereto.

Based on the above embodiments, when performing the video quality evaluation on the target transcoded video, the video frames in the target transcoded video can be compared with the corresponding video frames in the source video through the obtained frame cadence information, so that the video quality evaluation result corresponding to each video frame in the target transcoded video can be obtained.

For example, the video quality evaluation result of each video frame in the target transcoded video can be determined by comparing the similarity between the video frame in the target transcoded video and the corresponding video frame in the source video. The higher the similarity, the higher the video frame quality in the video quality evaluation result of the video frame in the corresponding target transcoded video. The higher the similarity, the smaller the difference between the video frame after transcoding and the video frame before transcoding, and the quality of the video frame is not significantly affected by transcoding.

For example, the M-th frame of video in the target transcoded video corresponds to the N-th frame of video in the source video, that is, the M-th frame of video in the target transcoded video is obtained by transcoding the N-th frame of video in the source video. By obtaining the similarity between the M-th frame of video and the N-th frame of video, the video quality evaluation result of the M-th frame can be obtained; and the video quality evaluation result can be measured at different levels, such as first level, second level or third level, etc. The video quality evaluation result can also be measured by scores; for example, the similarity between the above video frames is 88%, and the video quality evaluation result of the corresponding video frame in the target transcoded video can be determined according to the similarity, for example, it can be 88; and the score can range from 0 to 100, but the embodiment is not limited thereto.

After obtaining the video quality evaluation result of each frame in the target transcoded video, the video quality evaluation result of the target transcoded video can be obtained by accumulating the video quality evaluation result of each frame. In the embodiment, the one-to-one correspondence between the video frames in the target transcoded video and the video frames in the source video can be achieved through the video frame cadence information, so that the accuracy of the video quality evaluation result of the target transcoded video finally obtained can be guaranteed.

In the above embodiments, instead of obtaining the video quality evaluation result of each video frame in the target transcoded video, and then determining the video quality evaluation result of the target transcoded video according to the video quality evaluation result of each video frame, the video quality evaluation result of the target transcoded video can also be determined by obtaining the video quality evaluation results of part of video frames in the target transcoded video.

Illustratively, because different users may be interested in different parts of the video, video quality evaluation can be performed on the content that users are interested in or some specific target video frames, and then the video quality evaluation of the target transcoded video can be determined. For example, for martial arts action movies, video quality evaluation can be performed on the video frames corresponding to the fighting scenes, so that the video quality evaluation of the target transcoded video can be implemented quickly and the video quality evaluation of the target transcoded video can also be implemented accurately.

In an embodiment, a higher weight can be set for the quality evaluation results of the parts that users are interested in or some specific target video frames, and a lower weight can be set for the video evaluation results of the video frames corresponding to some less important contents, so that the video quality evaluation of the target transcoded video can be more accurately implemented by a weighted sum of the video evaluation quality results of the video frames in the target transcoded video.

Based on the frame cadence information obtained in the above embodiments, the denoising processing can be performed on the target transcoded video to eliminate the noise caused by transcoding in the target transcoded video.

In terms of the video before and after transcoding, it is the resolution, frame rate or bit rate, etc., of the video, that is mainly changed. Therefore, based on the frame cadence information obtained above, by comparing the corresponding video frames between the target transcoded video and the source video, the noise caused by transcoding in the target transcoded video can be determined, so that the noise in the target transcoded video can be accurately eliminated by locating the noise in the target transcoded video.

In an embodiment, a preset model can also be trained by using training samples, and in the case where the training meets a stopping condition, the training can be stopped to obtain a video denoising model. The preset model can be a model such as a neural network model or the like, and the embodiment is not limited thereto.

The training samples can include videos before transcoding and videos after transcoding, and the frame cadence information between the video frames before and after transcoding, so that the correspondence between the video frames before and after transcoding can be determined through the frame cadence information. By annotating the noise in the video frame after transcoding in the training samples, the preset model can be better trained during the training process of the preset model. That is, the trained model can determine the video frame containing noise in the video before transcoding (i.e., the source video), which is equivalent to obtaining a degeneration network. The inverse transformation of the restoring network can be obtained through the video frame in the corresponding source video, and then the noise in the video frame can be eliminated.

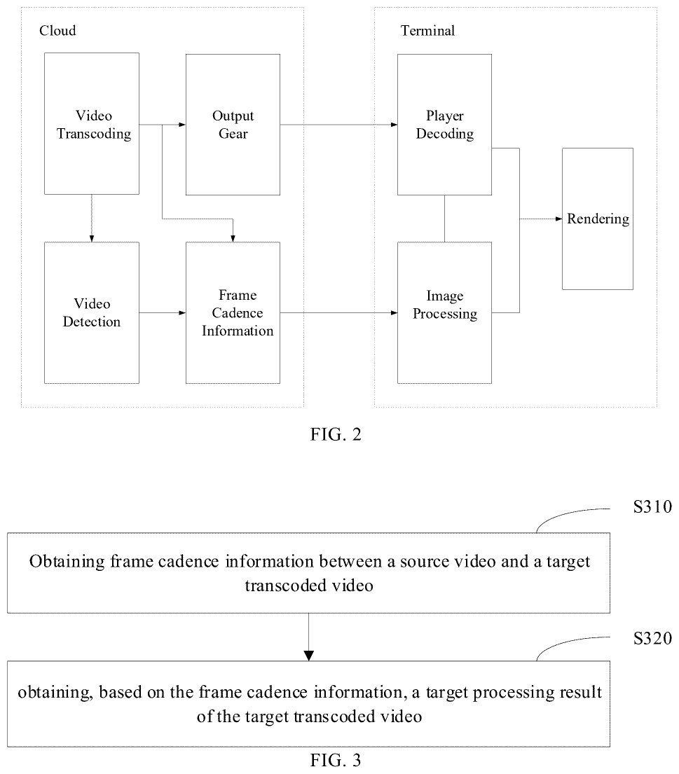

In the embodiment provided by the present disclosure, as shown in FIG. 2, because the cloud server has powerful data processing capability, the source video can be transcoded in the cloud, and the target transcoded video obtained after transcoding can be sent to a corresponding terminal. During the transcoding process, the frame cadence information between the source video and the target transcoded video can be obtained, and the cloud can send a file containing the frame cadence information to the terminal.

In an embodiment, the cloud can transcode the source video according to the network status of the terminal, the performance of the terminal or the selection of the user, etc.; and its output gear can output a video with corresponding resolution or bit rate, such as a video transcoded to 720P, and send the video after transcoding, that is, the target transcoded video, to the terminal. When receiving the target transcoded video, the terminal can decode the target transcoded video through the player on the terminal, and further process the decoded video according to the received frame cadence information.

For example, according to the frame cadence information, brightness information, illumination information and/or color information in the source video can be obtained, and the decoded video image can be processed to improve the image quality of the video. In this way, by using the cloud to parse the video portrait, the frame cadence information is obtained, and the frame cadence information is used to help the terminal achieve accurate processing of video frames. For example, it can achieve better color processing of video content and adjust the brightness of each frame. With the help of the frame cadence information, it can achieve different intensity of processing on each video frame and enhance the adaptive ability of video processing.

In this way, through terminal-cloud collaboration, transcoding is performed through the cloud and the video portrait is parsed, so as to obtain the frame cadence information before and after transcoding; therefore, the video can be further accurately processed on the terminal, the adaptive processing ability can be improved, and the image quality of the video can be improved. Especially in some mid-to-high-end devices, there is already a certain level of video processing capability.

Based on the above embodiments, an embodiment of the present disclosure provides a video processing method. As shown in FIG. 3, the method can include the following steps:
step S310: obtaining frame cadence information between a source video and a target transcoded video.

The frame cadence information represents a video frame correspondence between the source video and the target transcoded video, and the target transcoded video includes a video obtained by transcoding the source video.

During the transcoding process of the video, the number of video frames before and after transcoding may be different, resulting in that the video frames before and after transcoding will not be accurately matched; and it may affect the processing result of the video during the subsequent processing of the video after transcoding.

Therefore, in the embodiment, during the process of transcoding the source video to obtain the target transcoded video, the frame cadence information between the source video and the target transcoded video is obtained by determining the correspondence of video frames between the target transcoded video and the source video.

In the embodiment, during the process of obtaining the target transcoded video by transcoding the source video, there may be multiple times of transcoding; therefore, it is needed to obtain the correspondence of video frames of each transcoded video before and after transcoding, so as to obtain the frame cadence information between the target transcoded video and the source video.

Specifically, an intermediate transcoded video is obtained by transcoding the source video, and first frame cadence information between the source video and the intermediate transcoded video is obtained. The target transcoded video is obtained by transcoding the intermediate transcoded video, and second frame cadence information between the intermediate transcoded video and the target transcoded video is obtained. Based on the first frame cadence information and the second frame cadence information, the frame cadence information between the source video and the target transcoded video is obtained.

In this way, according to the first frame cadence information and the second frame cadence, frame cadence combination information can be obtained by combining the first frame cadence information and the second frame cadence information, and then the frame cadence information between the source video and the target transcoded video can be determined. In an embodiment, during the above-mentioned transcoding process, more intermediate transcoded videos may appear, and the frame cadence information between the source video and the target transcoded video can be finally determined through the frame cadence information obtained from the intermediate transcoded videos before and after transcoding.

Step S320: obtaining, based on the frame cadence information, a target processing result of the target transcoded video.

In an embodiment, the corresponding video frames between the source video and the target transcoded video can be obtained according to the frame cadence information, so that a more accurate video quality evaluation of the target transcoded video can be achieved by comparing the corresponding video frames between the target transcoded video and the source video, thus avoiding the possibility of disbelief in the video quality evaluation result of the target transcoded video due to the inaccurate correspondence between the video frames in the source video and the video frames in the target transcoded video.

In an embodiment, the target transcoded video can also be denoised by combining the above frame cadence information. The corresponding video frames between the source video and the target transcoded video can be obtained through the frame cadence information, and therefore, by comparing the video frames in the target transcoded video with the video frames in the source video respectively, the noise in the target transcoded video can be accurately located for denoising.

In an embodiment, the transcoding processing of the source video can also be realized in the cloud, and the frame cadence information can be obtained. By sending the target transcoded video after transcoding and the frame cadence information to the terminal, the decoder on the terminal side can decode the target transcoded video, and achieve more accurate video processing, such as HDR or super-resolution processing, etc., of the decoded video in combination with the frame cadence information, so as to obtain a video with better image quality.

In the video processing method provided by the embodiment of the present disclosure, frame cadence information between the source video and the target transcoded video is obtained, and a target processing result of the target transcoded video is obtained based on the frame cadence information. Because the frame cadence information can reflect the correspondence of video frames between the source video and the target transcoded video, a more accurate target processing result of the target transcoded video can be achieved through the frame cadence information. For example, a more accurate video quality evaluation result of the target transcoded video can be obtained, the noise in the target transcoded video can be eliminated more accurately, or a more accurate processing, such as super-resolution processing, etc., can be achieved for the target transcoded video.

Based on the above embodiments, in another embodiment provided by the present disclosure, the above step S320 can specifically include the following steps:
In step S321, based on the frame cadence information, video frames in the target transcoded video are compared with corresponding video frames in the source video, respectively, so as to obtain a video frame quality evaluation result of each video frame in the target transcoded video.
In step S322, based on the video frame quality evaluation result of each video frame, the video quality evaluation result of the target transcoded video is obtained.

In an embodiment, the video quality evaluation result of each video frame or the video quality evaluation results of part of video frames in the target transcoded video can be obtained firstly, and then the video quality evaluation result of the target transcoded video can be determined.

When obtaining the video quality evaluation results of the video frames in the target transcoded video, the similarities between the video frames in the target transcoded video and the corresponding video frames in the source video can be obtained. Based on the similarities, the video frame quality evaluation result of each video frame in the target transcoded video are obtained. In this way, the video quality evaluation result of the target transcoded video can be determined according to the video quality evaluation results of the video frames in the target transcoded video. For example, the video frame quality evaluation result of each video frame in the target transcoded video can be weighted and summed, or accumulated, to obtain the video quality evaluation results of the target transcoded video. For details, please refer to the description of the above embodiments, which will not be repeated here.

Based on the above embodiments, in another embodiment provided by the present disclosure, the above step S320 can specifically include the following steps:
In step S323, based on the frame cadence information, video frames in the target transcoded video are compared with video frames in the source video to obtain the noise in the target transcoded video.
In step S324, denoising processing is performed on the noise in the target transcoded video to obtain a denoised target transcoded video.

In the embodiment, based on the frame cadence information obtained above, by comparing the corresponding video frames between the target transcoded video and the source video, the noise caused by transcoding in the target transcoded video can be determined, so that the noise in the target transcoded video can be accurately eliminated by locating the noise in the target transcoded video

For example, feature extraction can be performed on the video frames of the source video and the target transcoded video respectively, and by comparing features of them, the noise in the target transcoded video can be located, so as to realize the denoising processing of the target transcoded video.

In the embodiment, because the features, such as texture and content, etc., of the video generally do not change before and after transcoding, these features can be excluded, and then the noise can be located.

In the embodiment, the denoising processing of the target transcoded video can be implemented through a model. For example, the source video, the target transcoded video and the frame cadence information can be input into a video denoising model, so as to obtain the denoised target transcoded video. A preset model is trained by using training samples to obtain the video denoising model; the training samples include a to-be-transcoded video and a transcoded video, and frame cadence information between the to-be-transcoded video and the transcoded video; and the video frames in the transcoded video include noise annotation information. For details, please refer to the description of the above-mentioned embodiments, which will not be repeated here.

Based on the above embodiments, in another embodiment provided by the present disclosure, the method can further include the following steps:
In step S330, the target transcoded video is decoded to obtain a decoded target video.
In step S340, target video information in the source video is obtained.
In step S350, target image processing is performed on the target video based on the target video information and the frame cadence information.

In the embodiment, referring to FIG. 2, because the cloud server has powerful data processing capability, the source video can be transcoded through the cloud, and the target transcoded video obtained after transcoding can be sent to the terminal. And the frame cadence information obtained during the transcoding process is sent to the terminal.

In this way, the terminal receives the target transcoded video sent by the cloud, and decode the target transcoded video through the player; and combined with the received frame cadence file, it can realize the super-resolution or HDR processing, etc., of the decoded video frames, so as to optimize the image quality of the video.

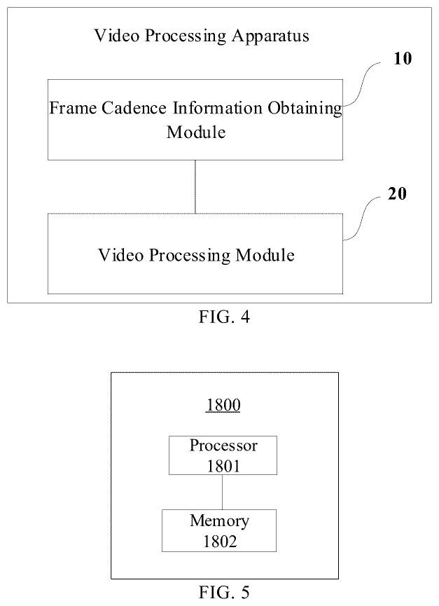

In the case where the functional modules are divided using the corresponding functions, an embodiment of the present disclosure provides a video processing apparatus, which can be a server, a terminal or a chip applied to a server. FIG. 4 is a schematic block diagram of functional modules of a video processing apparatus provided by an exemplary embodiment of the present disclosure. As shown in FIG. 4, the video processing apparatus includes:
a frame cadence information obtaining module 10, configured to obtain frame cadence information between a source video and a target transcoded video, wherein the frame cadence information represents a video frame correspondence between the source video and the target transcoded video, and the target transcoded video includes a video obtained by transcoding the source video; and
a video processing module 20, configured to obtain, based on the frame cadence information, a target processing result of the target transcoded video.

In another embodiment provided by the present disclosure, the apparatus further includes:
a transcoding module, configured to transcode the source video to obtain an intermediate transcoded video;
a first frame cadence information obtaining module, configured to obtain first frame cadence information between the source video and the intermediate transcoded video; and
a second frame cadence information obtaining module, configured to transcode the intermediate transcoded video to obtain the target transcoded video, and obtain second frame cadence information between the intermediate transcoded video and the target transcoded video;
wherein the frame cadence information obtaining module is further configured to obtain, based on the first frame cadence information and the second frame cadence information, the frame cadence information between the source video and the target transcoded video.

In another embodiment provided by the present disclosure, the video processing module is specifically configured to:
compare, based on the frame cadence information, video frames in the target transcoded video with corresponding video frames in the source video respectively, so as to obtain a video frame quality evaluation result of each video frame in the target transcoded video; and
obtain, based on the video frame quality evaluation result of each video frame, the video quality evaluation result of the target transcoded video.

In another embodiment provided by the present disclosure, the video processing module is further specifically configured to:
obtain similarities between the video frames in the target transcoded video and the corresponding video frames in the source video respectively; and
obtain, based on the similarities, the video frame quality evaluation result of each video frame in the target transcoded video.

In another embodiment provided by the present disclosure, the video processing module is further specifically configured to:
accumulate the video frame quality evaluation result of each video frame in the target transcoded video to obtain the video quality evaluation result of the target transcoded video.

In another embodiment provided by the present disclosure, the video processing module is further specifically configured to:
compare, based on the frame cadence information, video frames in the target transcoded video with video frames in the source video, so as to obtain noise in the target transcoded video; and
perform denoising processing on the noise in the target transcoded video to obtain a denoised target transcoded video.

In another embodiment provided by the present disclosure, the video processing module is further specifically configured to:
input the source video, the target transcoded video and the frame cadence information into a video denoising model, so as to obtain a denoised target transcoded video, wherein a preset model is trained by using training samples to obtain the video denoising model, the training samples includes a to-be-transcoded video and a transcoded video, and frame cadence information between the to-be-transcoded video and the transcoded video, and video frames in the transcoded video include noise annotation information.

In another embodiment provided by the present disclosure, the apparatus further includes:
a decoding module, configured to decode the target transcoded video to obtain a decoded target video;
a video information obtaining module, configured to obtain target video information in the source video;
an image processing module, configured to perform target image processing on the target video based on the target video information and the frame cadence information.

The apparatus part corresponds to the above method, and please refer to the corresponding description of the method embodiments for details, which will not be repeated here.

In the video processing apparatus provided by the embodiment of the present disclosure, frame cadence information between the source video and the target transcoded video is obtained, and a target processing result of the target transcoded video is obtained based on the frame cadence information. Because the frame cadence information can reflect the correspondence of video frames between the source video and the target transcoded video, a more accurate target processing result of the target transcoded video can be achieved through the frame cadence information. For example, a more accurate video quality evaluation result of the target transcoded video can be obtained, the noise in the target transcoded video can be eliminated more accurately, or a more accurate processing, such as super-resolution processing, etc., can be achieved for the target transcoded video.

An embodiment of the present disclosure further provides an electronic device, which includes: at least one processor; a memory, configured to store instructions executable by the at least one processor; wherein the at least one processor is configured to execute the instructions to implement the method disclosed in the embodiments of the present disclosure.

FIG. 5 is a schematic structural diagram of an electronic device provided by an exemplary embodiment of the present disclosure. As shown in FIG. 5, the electronic device 1800 includes at least one processor 1801 and a memory 1802 coupled to the processor 1801, and the processor 1801 can execute the corresponding steps in the above method disclosed in the embodiments of the present disclosure.

The above processor 1801 can also be called a central processing unit (CPU), which can be an integrated circuit chip with signal processing capability. Each step in the above method disclosed in the embodiments of the present disclosure can be completed by instructions in the form of software or a hardware integrated logic circuit in the processor 1801. The above processor 1801 can be a general-purpose processor, a digital signal processor (DSP), an application specific integrated circuit (ASIC), a field-programmable gate array (FPGA) or another programmable logic device, a discrete gate or a transistor logic device, and discrete hardware component. The general-purpose processor can be a microprocessor, or the processor may be any conventional processor or the like. The operations of the method disclosed in the embodiments of the present disclosure can be directly performed and completed by a hardware decoding processor, or can be performed and completed by using a combination of hardware and software modules in the decoding processor. The software module can be located on the memory 1802, such as a random access memory, a flash memory, a read-only memory, a programmable read-only memory, an electrically erasable programmable memory, a register, or other mature storage medium in this field. The processor 180 reads information in the memory 1802 and completes the steps of the above method in combination with hardware thereof.

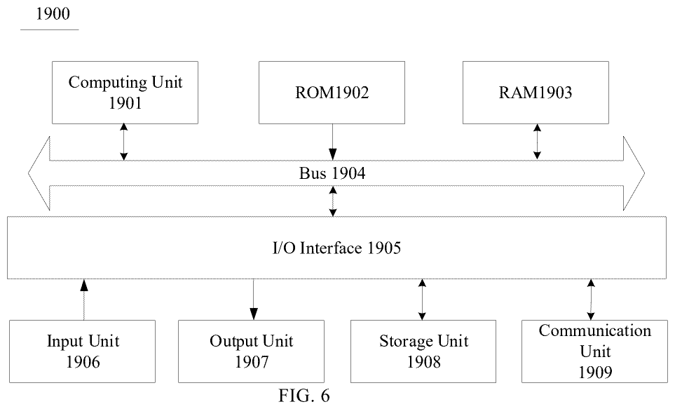

In addition, in the case where various operations/processing according to the present disclosure are implemented by software and/or firmware, programs constituting the software can be installed from a storage medium or a network to a computer system with a dedicated hardware structure, such as the computer system 1900 shown in FIG. 6. When the computer system is installed with various programs, the computer system can perform various functions, including the functions described above, etc. FIG. 6 is a structural block diagram of a computer system provided by an exemplary embodiment of the present disclosure.

The computer system 1900 is intended to represent various forms of digital electronic computer devices, such as a laptop computer, a desktop computer, a workstation, a personal digital assistant, a server, a blade server, a mainframe computer, and other suitable computers. The computer system 1900 can further represent various forms of mobile apparatuses, such as a personal digital assistant, a cellular phone, a smart phone, a wearable device, and other similar computing apparatuses. The components shown in the present disclosure, their connections and relationships, and their functions are merely examples, and are not intended to limit the implementation of the present disclosure described and/or claimed herein.

As shown in FIG. 6, the computer system 1900 includes a computing unit 1901, and the computing unit 1901 is configured to execute various appropriate actions and processing according to a computer program stored in a read-only memory (ROM) 1902 or loaded from a storage unit 1908 to a random access memory (RAM) 1903. In the RAM 1903, various programs and data required for the computer system 1900 can also be stored. The computing unit 1901, the ROM 1902 and the RAM 1903 can be connected with each other through a bus 1904. An input/output (I/O) interface 1905 is also connected to the bus 1904.

A plurality of components in the computer system 1900 are connected to the I/O interface 705, including: an input unit 1906, an output unit 1907, the storage unit 1908, and a communication unit 1909. The input unit 1906 can be any type of device capable of entering information to the computer system 1900. The input unit 1906 can receive entered digit or character information, and generate a key signal input related to user settings and/or function control of the computer system 1900. The output unit 1907 can be any type of device capable of presenting information, and can include, but is not limited to, a display, a speaker, a video/audio output terminal, a vibrator, and/or a printer. The storage unit 1908 can include, but is not limited to, a magnetic disk or an optical disk. The communication unit 1909 allows the computer system 1900 to exchange information/data with other devices through a network such as the Internet, and can include, but is not limited to, a modem, a network interface card, an infrared communication device, a wireless communication transceiver, and/or a chipset, such as a Bluetooth device, a WiFi device, a WiMax device, a cellular communication device and/or the like.

The computing unit 1901 can be various types of general and/or dedicated processing components with processing and computing capabilities. Some examples of the computing unit 1901 include but not limited to a central processing unit (CPU), a graphics processing unit (GPU), various dedicated artificial intelligence (AI) computing chips, various computing units running a machine learning model algorithm, a digital signal processor (DSP), and any appropriate processor, controller, microcontroller, etc. The computing unit 1901 executes various methods and processing as described above. For example, in some embodiments, the above method disclosed in the embodiments of the present disclosure can be implemented as a computer software program, which is physically contained on a machine-readable medium, such as the storage unit 1908. In some embodiments, a part or all of the computer program can be loaded and/or installed on the electronic device via the ROM 1902 and/or the communication unit 1909. In some embodiments, the computing unit 1901 can be configured to perform the above method disclosed in the embodiments of the present disclosure in any other suitable manner (e.g., by means of firmware).

An embodiment of the present disclosure further provides a computer-readable storage medium, wherein when instructions on the computer-readable storage medium are executed by a processor of an electronic device, the electronic device is enabled to perform the above method disclosed in the embodiments of the present disclosure.

In the embodiment of the present disclosure, the computer-readable storage medium can be a tangible medium, which may contain or store a program for use by an instruction execution system, apparatus, or device or for use in combination with the instruction execution system, apparatus, or device. The computer-readable storage medium can include, but is not limited to an electrical, magnetic, optical, electromagnetic, infrared, or semiconductor system, apparatus, or device, or any suitable combination of the foregoing. More specifically, the computer-readable storage medium can include an electrical connection having one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing.

The above-described computer-readable medium may be included in the above-described electronic device; or may also exist alone without being assembled into the electronic device.

An embodiment of the present disclosure further provides a computer program product, including a computer program, wherein the computer program, when executed by a processor, implement the above method disclosed in the embodiment of the present disclosure.

The computer program code for executing the operation of the present disclosure may be written in one or more programming languages or combinations thereof, the above programming language includes but is not limited to object-oriented programming languages such as Java, Smalltalk, and C++, and also includes conventional procedural programming languages such as a “C” language or a similar programming language. The program code may be completely executed on the user's computer, partially executed on the user's computer, executed as a standalone software package, partially executed on the user's computer and partially executed on a remote computer, or completely executed on the remote computer or server. In the case involving the remote computer, the remote computer may be connected to the user's computer by any types of networks, including LAN or WAN, or may be connected to an external computer (such as connected by using an internet service provider through the Internet).

The flow diagrams and the block diagrams in the drawings show possibly achieved system architectures, functions, and operations of systems, methods, and computer program products according to various embodiments of the present disclosure. At this point, each box in the flow diagram or the block diagram may represent a module, a program segment, or a part of a code, the module, the program segment, or a part of the code contains one or more executable instructions for achieving the specified logical functions. It should also be noted that in some alternative implementations, the function indicated in the box may also occur in a different order from those indicated in the drawings. For example, two consecutively represented boxes may actually be executed basically in parallel, and sometimes it may also be executed in an opposite order, this depends on the function involved. It should also be noted that each box in the block diagram and/or the flow diagram, as well as combinations of the boxes in the block diagram and/or the flow diagram, may be achieved by using a dedicated hardware-based system that performs the specified function or operation, or may be achieved by using combinations of dedicated hardware and computer instructions.

The involved units described in the embodiments of the present disclosure may be achieved by a mode of software, or may be achieved by a mode of hardware. Herein, the name of the unit does not constitute a limitation for the unit itself in some cases.

The functions described above in this article may be at least partially executed by one or more hardware logic components. For example, non-limiting exemplary types of the hardware logic component that may be used include: a field programmable gate array (FPGA), an application specific integrated circuit (ASIC), an application specific standard product (ASSP), a system on chip (SOC), a complex programmable logic device (CPLD) and the like.

The above description is only an explanation of some embodiments of the present disclosure and the applied technical principles. Those skilled in the art should understand that the scope of disclosure involved in the present disclosure is not limited to the technical solutions formed by the specific combination of the above technical features, and at the same time, should also cover other technical solutions formed by arbitrarily combining the above-described technical features or equivalent features without departing from the above disclosed concept. For example, the above-described features and the technical features disclosed in the present disclosure (but not limited thereto) having similar functions are replaced with each other to form a technical solution.

Although some specific embodiments of the present disclosure have been described in detail by way of examples, those skilled in the art should understand that the above examples are only for the purpose of illustration but not for limiting the scope of the present disclosure. It should be understood by those skilled in the art that modifications to the above-described embodiments maybe made without departing from the scope and spirit of the present disclosure. The scope of the present disclosure is defined by the appended claims.

1. A video processing method, comprising:
obtaining frame cadence information between a source video and a target transcoded video, wherein the frame cadence information represents a video frame correspondence between the source video and the target transcoded video, and the target transcoded video comprises a video obtained by transcoding the source video; and
obtaining, based on the frame cadence information, a target processing result of the target transcoded video.

2. The method according to claim 1, further comprising:
transcoding the source video to obtain an intermediate transcoded video, and obtaining first frame cadence information between the source video and the intermediate transcoded video;
transcoding the intermediate transcoded video to obtain the target transcoded video, and obtaining second frame cadence information between the intermediate transcoded video and the target transcoded video; and
obtaining, based on the first frame cadence information and the second frame cadence information, the frame cadence information between the source video and the target transcoded video.

3. The method according to claim 1, wherein the obtaining a target processing result of the target transcoded video comprises:
comparing, based on the frame cadence information, video frames in the target transcoded video with corresponding video frames in the source video respectively, so as to obtain a video frame quality evaluation result of each video frame in the target transcoded video; and
obtaining, based on the video frame quality evaluation result of each video frame, the video quality evaluation result of the target transcoded video.

4. The method according to claim 3, wherein the comparing video frames in the target transcoded video with corresponding video frames in the source video respectively, so as to obtain a video frame quality evaluation result of each video frame in the target transcoded video, comprises:
obtaining similarities between the video frames in the target transcoded video and the corresponding video frames in the source video respectively; and
obtaining, based on the similarities, the video frame quality evaluation result of each video frame in the target transcoded video.

5. The method according to claim 3, wherein the obtaining a video quality evaluation result of the target transcoded video comprises:
accumulating the video frame quality evaluation result of each video frame in the target transcoded video to obtain the video quality evaluation result of the target transcoded video.

6. The method according to claim 1, wherein the obtaining a target processing result of the target transcoded video comprises:
comparing, based on the frame cadence information, video frames in the target transcoded video with video frames in the source video, so as to obtain noise in the target transcoded video; and
performing denoising processing on the noise in the target transcoded video to obtain a denoised target transcoded video.

7. The method according to claim 1, wherein the obtaining a target processing result of the target transcoded video comprises:
inputting the source video, the target transcoded video and the frame cadence information into a video denoising model, so as to obtain a denoised target transcoded video, wherein a preset model is trained by using training samples to obtain the video denoising model, the training samples comprise a to-be-transcoded video and a transcoded video, and frame cadence information between the to-be-transcoded video and the transcoded video, and video frames in the transcoded video comprise noise annotation information.

8. The method according to claim 1, further comprising:
decoding the target transcoded video to obtain a decoded target video;
obtaining target video information in the source video; and
performing target image processing on the target video based on the target video information and the frame cadence information.

9. An electronic device, comprising:
at least one processor;
at least one memory, configured to store instructions executable by the at least one processor;
wherein the at least one processor is configured to execute the instructions to implement a video processing method, which comprises:
obtaining frame cadence information between a source video and a target transcoded video, wherein the frame cadence information represents a video frame correspondence between the source video and the target transcoded video, and the target transcoded video comprises a video obtained by transcoding the source video; and
obtaining, based on the frame cadence information, a target processing result of the target transcoded video.

10. The electronic device according to claim 9, wherein the method further comprises:
transcoding the source video to obtain an intermediate transcoded video, and obtaining first frame cadence information between the source video and the intermediate transcoded video;
transcoding the intermediate transcoded video to obtain the target transcoded video, and obtaining second frame cadence information between the intermediate transcoded video and the target transcoded video; and
obtaining, based on the first frame cadence information and the second frame cadence information, the frame cadence information between the source video and the target transcoded video.

11. The electronic device according to claim 9, wherein the obtaining a target processing result of the target transcoded video comprises:
comparing, based on the frame cadence information, video frames in the target transcoded video with corresponding video frames in the source video respectively, so as to obtain a video frame quality evaluation result of each video frame in the target transcoded video; and
obtaining, based on the video frame quality evaluation result of each video frame, the video quality evaluation result of the target transcoded video.

12. The electronic device according to claim 11, wherein the comparing video frames in the target transcoded video with corresponding video frames in the source video respectively, so as to obtain a video frame quality evaluation result of each video frame in the target transcoded video, comprises:
obtaining similarities between the video frames in the target transcoded video and the corresponding video frames in the source video respectively; and
obtaining, based on the similarities, the video frame quality evaluation result of each video frame in the target transcoded video.

13. The electronic device according to claim 11, wherein the obtaining a video quality evaluation result of the target transcoded video comprises:
accumulating the video frame quality evaluation result of each video frame in the target transcoded video to obtain the video quality evaluation result of the target transcoded video.

14. The electronic device according to claim 9, wherein the obtaining a target processing result of the target transcoded video comprises:
comparing, based on the frame cadence information, video frames in the target transcoded video with video frames in the source video, so as to obtain noise in the target transcoded video; and
performing denoising processing on the noise in the target transcoded video to obtain a denoised target transcoded video.

15. The electronic device according to claim 9, wherein the obtaining a target processing result of the target transcoded video comprises:
inputting the source video, the target transcoded video and the frame cadence information into a video denoising model, so as to obtain a denoised target transcoded video, wherein a preset model is trained by using training samples to obtain the video denoising model, the training samples comprise a to-be-transcoded video and a transcoded video, and frame cadence information between the to-be-transcoded video and the transcoded video, and video frames in the transcoded video comprise noise annotation information.

16. The electronic device according to claim 9, wherein the method further comprises:
decoding the target transcoded video to obtain a decoded target video;
obtaining target video information in the source video; and
performing target image processing on the target video based on the target video information and the frame cadence information.

17. A non-transient computer-readable storage medium, comprising computer-executable instructions, wherein the computer-executable instructions, upon being executed by a computer processor, perform a video processing method, comprising:
obtaining frame cadence information between a source video and a target transcoded video, wherein the frame cadence information represents a video frame correspondence between the source video and the target transcoded video, and the target transcoded video comprises a video obtained by transcoding the source video; and
obtaining, based on the frame cadence information, a target processing result of the target transcoded video.

18. The non-transient computer-readable storage medium according to claim 17, wherein the method further comprises:
transcoding the source video to obtain an intermediate transcoded video, and obtaining first frame cadence information between the source video and the intermediate transcoded video;
transcoding the intermediate transcoded video to obtain the target transcoded video, and obtaining second frame cadence information between the intermediate transcoded video and the target transcoded video; and
obtaining, based on the first frame cadence information and the second frame cadence information, the frame cadence information between the source video and the target transcoded video.

19. The non-transient computer-readable storage medium according to claim 17, wherein the obtaining a target processing result of the target transcoded video comprises:
comparing, based on the frame cadence information, video frames in the target transcoded video with corresponding video frames in the source video respectively, so as to obtain a video frame quality evaluation result of each video frame in the target transcoded video; and
obtaining, based on the video frame quality evaluation result of each video frame, the video quality evaluation result of the target transcoded video.

20. The non-transient computer-readable storage medium according to claim 19, wherein the comparing video frames in the target transcoded video with corresponding video frames in the source video respectively, so as to obtain a video frame quality evaluation result of each video frame in the target transcoded video, comprises:
obtaining similarities between the video frames in the target transcoded video and the corresponding video frames in the source video respectively; and
obtaining, based on the similarities, the video frame quality evaluation result of each video frame in the target transcoded video.
